(19) United States
(12) Patent Application Publication
(10) Pub. No.: US 2026/0243200 A1
(43) Pub. Date: Aug. 20, 2026

(54) ENGINE SYSTEM FOR AN AIRCRAFT COMPRISING MEANS FOR HEATING DIHYDROGEN BEFORE SUPPLYING AN ENGINE WITH DIHYDROGEN

(71) Applicant: Airbus Operations SAS, TOULOUSE (FR)

(72) Inventor: Mathieu BELLEVILLE, TOULOUSE (FR)

(21) Appl. No.: 19/468,097

(22) Filed: Feb. 3, 2026

(30) Foreign Application Priority Data
Feb. 20, 2025 (FR) FR2501781

(51) Int. Cl. F02C 7/224; B64D 37/02; B64D 37/30; F02C 7/22; F02C 9/40

(52) U.S. Cl. CPC F02C 7/224; B64D 37/02; B64D 37/30; F02C 7/222; F02C 9/40; F05D 2210/12

(57) ABSTRACT

An engine system for an aircraft having an engine with a combustion chamber and a turbine unit, a first injector manifold for the combustion chamber, a second injector manifold arranged downstream of the turbine unit, an auxiliary conduit and a thermal loop with a first heat exchanger on an auxiliary conduit for dihydrogen, a second heat exchanger where the second injector manifold is oriented toward the second heat exchanger and conduits between the heat exchangers so as to heat the dihydrogen circulating in the auxiliary conduit before its arrival at the injector manifolds.

### CROSS-REFERENCES TO RELATED APPLICATIONS

This application claims the benefit of French Patent Application Number FR2501781 filed on Feb. 20, 2025, the entire disclosure of which is incorporated herein by way of reference.

### FIELD OF THE INVENTION

The present invention relates to an engine system for an aircraft comprising an engine consuming dihydrogen and means for heating the dihydrogen. The present invention further relates to an aircraft comprising at least one such engine system.

### BACKGROUND OF THE INVENTION

An aircraft conventionally comprises engines which ensure the displacement of said aircraft. These engines are conventionally supplied with a fuel in order to operate the engines. In order to reduce the carbon footprint, it is known to use dihydrogen as fuel in order to operate the engines. An aircraft thus comprises a tank in which the dihydrogen is stored. The dihydrogen is generally stored in liquid form and, for greater efficiency of the engine, it is desirable that the dihydrogen is in gaseous form and it is thus necessary to put a system in place which heats the dihydrogen before supplying the engine. It is desirable that this system makes it possible to heat the dihydrogen, even at the start-up time when the engine is cold.

### SUMMARY OF THE INVENTION

One subject of the present invention is to propose an engine system for an aircraft comprising an engine which is supplied with dihydrogen and a system which makes it possible to heat the dihydrogen leaving the tank before the introduction thereof into the engine.

To this end, an engine system is proposed for an aircraft comprising a tank in which the dihydrogen is stored, the engine system comprising:
an engine with a combustion chamber and a turbine unit arranged downstream of the combustion chamber,
a first injector manifold arranged in the combustion chamber,
   a second injector manifold arranged downstream of the turbine unit,
an auxiliary conduit arranged to transport dihydrogen from the tank to each injector manifold, and
a thermal loop comprising:
   a first heat exchanger arranged on the auxiliary conduit upstream of the two injector manifolds,
   a second heat exchanger arranged so that the second injector manifold is oriented toward the second heat exchanger, and
   a series of conduits fluidically connected between the first heat exchanger and the second heat exchanger so as to heat the dihydrogen circulating in the auxiliary conduit before its arrival at the injector manifolds.

With such an arrangement, even at start-up when the engine is cold, the dihydrogen is heated before being supplied to the engine.

According to one particular embodiment, the series of conduits comprises a transfer conduit forming a loop, a first end thereof being arranged in the first heat exchanger and a second end thereof being arranged in the second heat exchanger, where the transfer conduit is filled with a moving heat transfer fluid.

According to a further particular embodiment, the series of conduits consists of the auxiliary conduit which successively passes through the first heat exchanger, the second heat exchanger and then the first heat exchanger in order to reach the injector manifolds.

Advantageously, the second heat exchanger is arranged downstream of the second injector manifold.

Advantageously, the second heat exchanger is arranged upstream of the second injector manifold.

Advantageously, the engine system comprises, for each injector manifold, a control valve which is mounted on the auxiliary conduit between the first heat exchanger and said injector manifold, and a control unit which is arranged to control the opening and closing of each control valve independently.

The invention also proposes an aircraft comprising:
a tank in which dihydrogen is stored, and
an engine system according to one of the preceding variants where the auxiliary conduit is fluidically connected to the tank.

### BRIEF DESCRIPTION OF THE DRAWINGS

The above-mentioned features of the invention, as well as others, will appear more clearly from reading the following description of an exemplary embodiment, said description being made relative to the accompanying drawings, in which:

FIG. 1 is a side view of an aircraft according to the invention;

FIG. 2 is a schematic view of an engine system according to a first embodiment of the invention;

FIG. 3 is a schematic view of an engine system according to a second embodiment of the invention;

FIG. 4 is a schematic view of an engine system according to a third embodiment of the invention; and

FIG. 5 is a schematic view of an example of the physical architecture of a control unit of the aircraft.

### DETAILED DESCRIPTION OF THE PREFERRED EMBODIMENTS

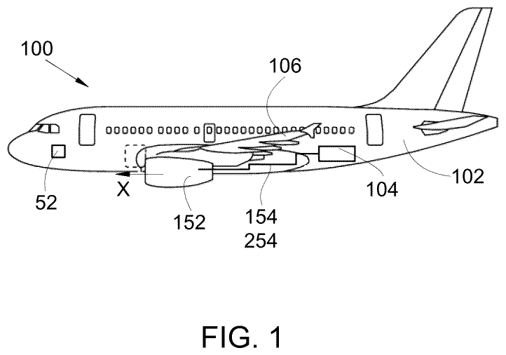

FIG. 1 shows an aircraft 100 which comprises a fuselage 102, at least one tank 104, in which dihydrogen, in particular liquid dihydrogen, is stored, being housed therein. The aircraft 100 also comprises a wing 106 on either side of the fuselage 102, at least one engine 152 which operates with gaseous dihydrogen being fixed below each wing. The engine 152 is of the turbojet or turboprop type, for example, and with a combustion chamber where the dihydrogen is combusted.

The aircraft 100 also comprises a control unit 52 and an auxiliary conduit 154, 254 which is fluidically connected to the outlet of the tank 104 and which is arranged to transport dihydrogen from the tank 104 to the engine 152.

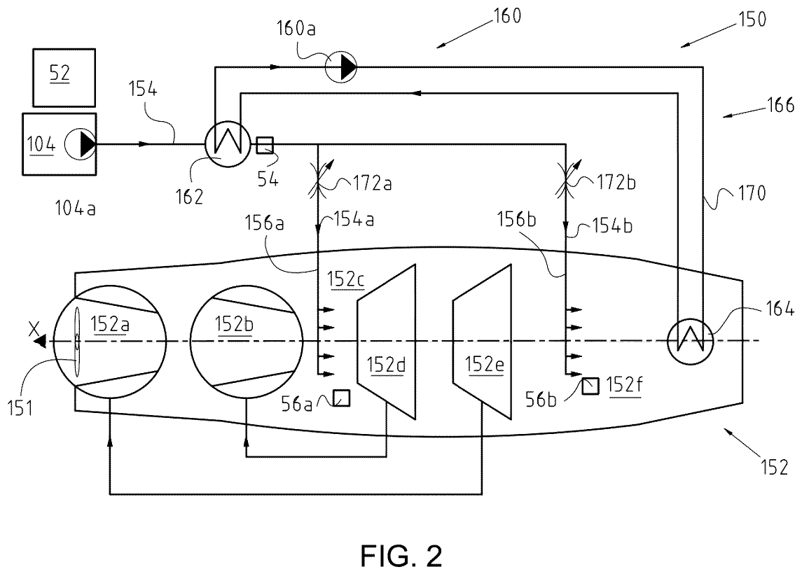

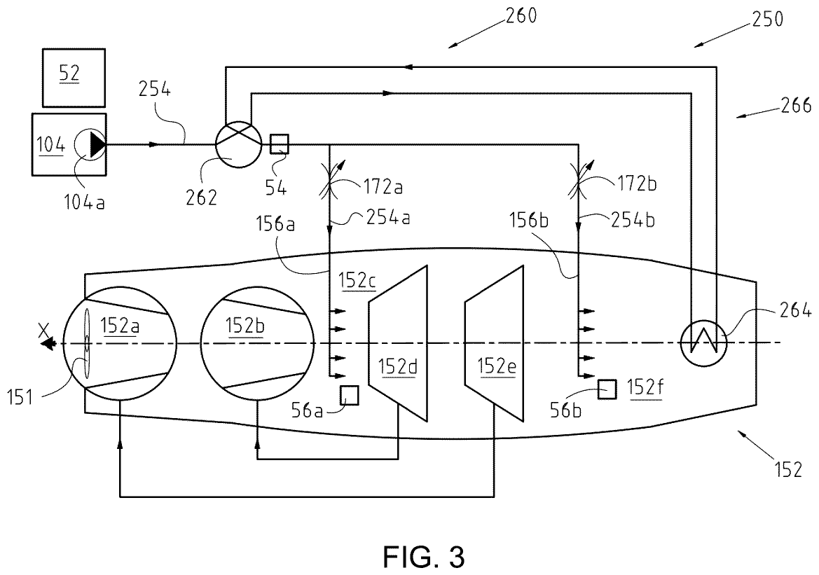

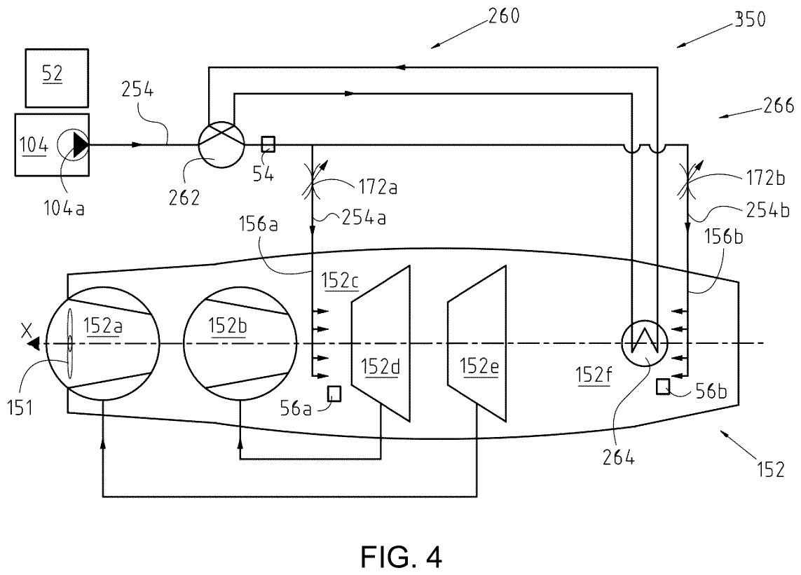

The aircraft 100 also comprises an engine system 150, 250, 350 according to the invention, three embodiments thereof being shown in FIGS. 2 to 4, where the longitudinal axis X represents the longitudinal axis of the engine 152 which is generally parallel to the longitudinal axis of the aircraft 100 and which is oriented toward the front of the aircraft 100. On the other hand, the terms “front” and “rear” are to be considered relative to a forward direction of travel of the aircraft 100 during the operation of the engine 152, this direction being shown schematically by the longitudinal axis X.

In each of the embodiments shown, the engine system 150, 250, 350 comprises an engine 152 and the engine 152 comprises, from the front to the rear, a compressor unit 152a-b with, for example, a fan 151 or a propeller, a combustion chamber 152c in which the dihydrogen is combusted and a turbine unit 152d-e downstream of the combustion chamber 152c.

In the embodiments of the invention shown here, the compressor unit 152a-b comprises a first compression stage 152a and a second compression stage 152b and, in the same manner, the turbine unit 152d-e comprises a first turbine stage 152d and a second turbine stage 152e. Conventionally, when the dihydrogen is combusted, it generates gases which escape toward the rear through the turbine unit 152d-e by driving in rotation the blades, which make up the turbine unit, about the longitudinal axis X and the blades forming the compressor unit 152a-b are in turn driven in rotation about the longitudinal axis X via a shaft which is fixed between the compressor unit 152a-b and the turbine unit 152d-e.

Thus, an air flow enters the engine 152 via the front, passes through the compressor unit 152a-b, arrives in the combustion chamber 152c where the dihydrogen is combusted, and then the combusted gases then escape through the turbine unit 152d-e and finally through a nozzle 152f downstream of the turbine unit 152d-e.

The engine system 150, 250, 350 also comprises a first injector manifold 156a where the injectors are arranged in the combustion chamber 152c so as to spray dihydrogen, in particular in gaseous form, into the combustion chamber 152c where it is ignited by a first ignition system 56a associated with the injectors and ensuring the start of the combustion of the mixture of dihydrogen and dioxygen from the air, this combustion being thereafter self-sustaining.

The engine system 150, 250, 350 also comprises a second injector manifold 156b where the injectors are arranged downstream of the turbine unit 152d-e. The second injector manifold 156b is arranged in the gaseous flow circulating in the engine 152 at the rear of the turbine unit 152d-e and more particularly in this case in the nozzle 152f.

The auxiliary conduit 154, 254 is thus arranged to transport dihydrogen from the tank 104 to each injector manifold 156a-b. To this end, a supply pump 104a, which circulates the dihydrogen in the auxiliary conduit 154, 254, is provided in the region of the tank 104. Naturally, the supply pump 104a can be arranged at a different location on the auxiliary conduit 154, 254.

In each of the embodiments described herein, the engine system 150, 250, 350 also comprises a thermal loop 160, 260 which ensures the heating of the dihydrogen between the time when it leaves the tank 104 and before it reaches the combustion chamber 152c.

The thermal loop 160, 260 takes a first form in the case of the first embodiment of the invention and a second form in the case of the second and third embodiments of the invention.

Generally, the thermal loop 160, 260 comprises a first heat exchanger 162, 262, a second heat exchanger 164, 264 and a series of conduits 166, 266.

The first heat exchanger 162, 262 is arranged on the auxiliary conduit 154, 254 upstream of the two injector manifolds 156a-b and thus generally between the injector manifolds 156a-b and the tank 104.

The second heat exchanger 164, 264 is arranged so that the second injector manifold 156b is oriented toward the second heat exchanger 164, 264, i.e., the injectors expel the dihydrogen in the direction of the second heat exchanger 164, 264. The second heat exchanger 164, 264 is thus arranged in the gas flow to the rear of the turbine unit 152d-e and more particularly in this case in the nozzle 152f.

As mentioned above, a second ignition system 56b, which is associated with the injectors and ensures the start of the combustion of the dihydrogen leaving the injectors of the second injector manifold 156b, is also provided, this combustion being thereafter self-sustaining. This combustion oriented toward the second heat exchanger 164, 264 ensures the heating of the dihydrogen or a heat transfer fluid as is explained below.

The series of conduits 166, 266 forms a network of conduits which is fluidically connected between the first heat exchanger 162, 262 and the second heat exchanger 164, 264 so as to heat the dihydrogen circulating in the auxiliary conduit 154, 254 before its arrival at the injector manifolds 156a-b and more particularly the first injector manifold 156a.

Thus, the dihydrogen is heated before its arrival in the combustion chamber 152c, which ensures improved efficiency of the engine 152.

In the first embodiment of the invention, the heating of the dihydrogen is carried out via a heat exchange with a heat transfer fluid. The series of conduits 166 thus comprises a transfer conduit 170 which forms a loop in which the heat transfer fluid circulates, in this case by being moved by a transfer pump 160a arranged on the transfer conduit 170.

The heat transfer fluid thus circulates in a loop between a first end and a second end of the loop. The first end is arranged in the first heat exchanger 162 so as to heat the dihydrogen circulating in the auxiliary conduit 154 by exchanging calories with the heat transfer fluid. The second end is arranged in the second heat exchanger 164 so as to heat the heat transfer fluid by exchanging calories with the dihydrogen which combusts at the outlet of the injectors of the second injector manifold 156b.

The dihydrogen leaving the tank 104 thus passes through the first heat exchanger 162 where it is heated upon contact with the heat transfer fluid, and then it reaches the two injector manifolds 156a-b to supply the combustion chamber 152c and heat the second heat exchanger 164. During this time, the heat transfer fluid circulates between the two heat exchangers 162 and 164.

In the second and third embodiments of the invention, the heating of the dihydrogen is carried out via direct heating of the dihydrogen in the region of the second heat exchanger 264. The series of conduits 266 thus consists of the auxiliary conduit 254 which successively passes through the first heat exchanger 262, the second heat exchanger 264, and then again, the first heat exchanger 262, to reach the injector manifolds 156a-b in order to supply the combustion chamber 152c and heat the second heat exchanger 264.

The dihydrogen leaving the tank 104 thus passes through the first heat exchanger 262, where it is heated upon contact with the dihydrogen from the second heat exchanger 264, then it reaches the second heat exchanger 264 where it is heated by the exchange of calories with the dihydrogen which combusts at the outlet of the injectors of the second injector manifold 156b, then it passes again through the first heat exchanger 262 where it heats the dihydrogen from the tank 104 and finally it reaches the two injector manifolds 156a-b to supply the combustion chamber 152c and heat the second heat exchanger 264.

In the third embodiment of the invention, the second heat exchanger 264 is arranged downstream of the second injector manifold 156b and the injectors of the second injector manifold 156b expel the dihydrogen toward the front. This embodiment is particularly advantageous when the dihydrogen circulates directly in the second heat exchanger 264. More specifically, in the case of a leakage of dihydrogen in the region of said second heat exchanger 264, the dihydrogen from the leakage is automatically combusted in the region of the injectors of the second injector manifold 156b. Although this operating procedure is more particularly implemented in this embodiment, it can also be implemented in the second embodiment of the invention.

In the first and second embodiments of the invention, the second heat exchanger 164, 264 is arranged upstream of the second injector manifold 156b and the injectors of the second injector manifold 156b expel the dihydrogen to the rear.

In order to control, in particular, the requirements for heating the dihydrogen, the engine system 150, 250, 350 comprises for each injector manifold 156a-b a control valve 172a-b, in particular a flow control valve, which is mounted on the auxiliary conduit 154, 254 between the first heat exchanger 162, 262 and the relevant injector manifold 156a-b. Each control valve 172a-b can adopt an open position where it permits the dihydrogen to pass and a closed position where it does not permit the dihydrogen to pass, and it can adopt any intermediate position to allow the dihydrogen to pass to a greater or lesser extent.

In the embodiment of the invention shown in FIGS. 2 to 4, the auxiliary conduit 154, 254 is separated into two sub-conduits 154a-b, 254a-b each supplying one of the injector manifolds 156a-b and the associated control valve 172a-b is mounted on the corresponding sub-conduit 154a-b, 254a-b.

In order to control each control valve 172a-b independently, the engine system 150, 250, 350 also comprises a control unit 52 which is arranged to control the opening and closing of each control valve 172a-b independently of one another.

The control unit 52 also controls each ignition system 56a-b.

According to one mode of operation, in the first embodiment during the start-up of the engine 102, the first control valve 172a associated with the first injector manifold 156a is closed and the second control valve 172b associated with the second injector manifold 156b is opened. Thus, the dihydrogen supplies the second injector manifold 156b so as to heat the heat transfer fluid in the second heat exchanger 164 and, as long as the temperature of the dihydrogen at the outlet of the first heat exchanger 162 is insufficient, the control valves 172a-b remain in their current state. When the temperature of the dihydrogen at the outlet of the first heat exchanger 162 is sufficient, the first control valve 172a is opened to supply the combustion chamber 152c and thus trigger the start-up of the engine 152 and the second control valve 172b can be closed or adjusted in terms of opening.

A temperature sensor 54 is provided to ascertain the temperature of the dihydrogen at the outlet of the first heat exchanger 162, and this temperature sensor is in communication with the control unit 52.

In the same manner, in flight, if it is necessary to heat the dihydrogen at the outlet of the first heat exchanger 162, the second control valve 172b is adjusted in terms of opening to heat the heat transfer fluid and thus the dihydrogen at the outlet of the tank 104.

According to one mode of operation, in the second and third embodiments, during the start-up of the engine 102, the first control valve 172a associated with the first injector manifold 156a is closed and the second control valve 172b associated with the second injector manifold 156b is opened. Thus, the dihydrogen supplies the second injector manifold 156b to heat the dihydrogen in the second heat exchanger 264 and as long as the temperature of the dihydrogen at the outlet of the first heat exchanger 262 is insufficient, the control valves 172a-b remain in their current state. When the temperature of the dihydrogen at the outlet of the first heat exchanger 262 is sufficient, the first control valve 172a is opened to supply the combustion chamber 152c and thus trigger the start-up of the engine 152 and the second control valve 172b can be closed or adjusted in terms of opening.

A temperature sensor 54 is provided to ascertain the temperature of the dihydrogen at the outlet of the first heat exchanger 162, and this temperature sensor is in communication with the control unit 52.

In the same manner, in flight, if it is necessary to heat the dihydrogen at the outlet of the first heat exchanger 162, the second control valve 172b is adjusted in terms of opening to heat the heat transfer fluid and thus the dihydrogen at the outlet of the tank 104.

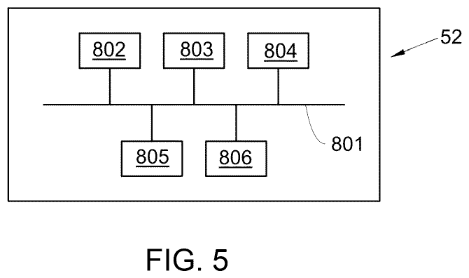

According to a particular embodiment shown in FIG. 5, the control unit 52 comprises, connected by a communication bus 801: a processor 802 or CPU (Central Processing Unit); a Random Access Memory RAM 803; a Read Only Memory ROM 804 or flash memory; a storage unit 805 such as a hard disk or storage medium reader such as an SD (Secure Digital) card reader; at least one communication interface 806 enabling, for example, the control unit to communicate with the valves, the pumps, the sensors, the lighting systems, etc.

The processor is capable of executing instructions uploaded into the RAM, when powered on by the ROM or the flash memory, from an external memory (not shown), a storage medium (such as an SD card) or a communication network. When the equipment is powered on, the processor is capable of reading instructions from the RAM and executing these instructions. These instructions constitute a computer program resulting in the execution by the processor of all or some of the algorithms and steps described above.

All or some of the algorithms and steps described above can be implemented in the form of software by executing a set of instructions by a programmable machine, for example a DSP (Digital Signal Processor) or a microcontroller, or can be implemented in physical form by a machine or dedicated component, for example an FPGA (Field Programmable Gate Array) or an ASIC (Application Specific Integrated Circuit).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An engine system for an aircraft having a tank in which dihydrogen is stored, the engine system comprising:
an engine with a combustion chamber and a turbine unit arranged downstream of the combustion chamber;
a first injector manifold arranged in the combustion chamber;
a second injector manifold arranged downstream of the turbine unit;
an auxiliary conduit arranged to transport dihydrogen from the tank to the first injector manifold and the second injector manifold; and
a thermal loop comprising:
a first heat exchanger arranged on the auxiliary conduit upstream of the first injector manifold and the second injector manifold,
a second heat exchanger arranged so that the second injector manifold is oriented toward the second heat exchanger, and
a plurality of conduits fluidically connected between the first heat exchanger and the second heat exchanger so as to heat dihydrogen circulating in the auxiliary conduit before the dihydrogen arrives at the first injector manifold and the second injector manifold.

2. The engine system as claimed in claim 1, wherein the plurality of conduits comprises a transfer conduit forming a loop, a first end of the transfer conduit arranged in the first heat exchanger and a second end of the transfer conduit arranged in the second heat exchanger,
wherein the transfer conduit is filled with a moving heat transfer fluid.

3. The engine system as claimed in claim 1, wherein the plurality of conduits includes the auxiliary conduit which successively passes through the first heat exchanger, the second heat exchanger, and then the first heat exchanger in order to reach the first injector manifold and the second injector manifold.

4. The engine system as claimed in claim 2, wherein the second heat exchanger is arranged downstream of the second injector manifold.

5. The engine system as claimed in claim 2, wherein the second heat exchanger is arranged upstream of the second injector manifold.

6. The engine system as claimed in claim 1, wherein for both the first injector manifold and the second injector manifold, the engine system comprises a control valve mounted on the auxiliary conduit between the first heat exchanger and a respective injector manifold, and
wherein the engine system further comprises a control unit arranged to control an opening and a closing of the control valves independently of each other.

7. An aircraft comprising:
a tank in which dihydrogen is stored; and
the engine system as claimed in claim 1,
wherein the auxiliary conduit is fluidically connected to the tank.
